(19) United States
(12) Patent Application Publication
(10) Pub. No.: US 2014/0278944 A1
(43) Pub. Date: Sep. 18, 2014

(54) UTILIZING A RESERVE PRICE FOR RANKING

(71) Applicant: MICROSOFT CORPORATION, Redmond, WA (US)

(72) Inventors: IAN KASH, CAMBRIDGE (GB); DINAN SRILAL GUNAWARDENA, CAMBRIDGE (GB); PETER KEY, CAMBRIDGE (GB); BEN ROBERTS, CAMBRIDGE (GB); THOMAS BORCHERT, CAMBRIDGE (GB); OMER HAR, CAMBRIDGE (GB)

(73) Assignee: MICROSOFT CORPORATION, Redmond, WA (US)

(21) Appl. No.: 13/799,943

(22) Filed: Mar. 13, 2013

(51) Int. Cl. G06Q 30/02

(52) U.S. Cl. CPC G06Q 30/0275
USPC 705/14.46; 705/14.71

(57) ABSTRACT

Methods, computer systems, and computer-storage media are provided for ranking ads. A reserve price is included in a calculation of a score to rank one or more advertisements for display. The calculation may further rely on a bid submitted by an advertiser for an advertisement, a click probability associated with the advertisement, a relevance of the advertisement to a search query and/or user, and the like. Once the reserve price is used to establish a score for one or more advertisements, a price is calculated for each of the one or more advertisements. The one or more advertisements may be displayed in an order indicated by the scores of each of the advertisements.

### BACKGROUND

In a sponsored search auction there may be typical tradeoffs that are made. Generally, a search query is received or identified from a user and bids are received from advertisers for one or more advertisements (“ads”). An ad platform must determine which ads to show in response to which search query and where to place them (i.e., in what order the ads should be displayed). This decision is where the tradeoffs come into play. There is a balance to achieve between the interests of each of the stakeholders: the user wants to be presented with meaningful and relevant content, the publisher wants revenue, and the advertisers want engagement. Ad placement is key to this balance.

In current sponsored search auctions, ad placement is determined by a ranking algorithm that is then used to determine pricing through payment rules of generalized second price (GSP) auctions. Payment is made when a user clicks on an ad (pay-per-click models). Hence, an ad's ranking affects the user both through a direct position effect and an indirect externality on non-sponsored or algorithmic content, has a consequent affect on an advertiser through the probability of engaging with or clicking on the ad, and affects the price paid by the advertiser and, thus, the revenue generated to the publisher. A higher position typically receives more attention from user and, thus, more clicks.

The current algorithms used generally rank ads by bids and a probability that an ad will be clicked (i.e., the likelihood that an ad will be clicked). That is, each advertiser submits a bid for an advertisement to be displayed. That bid is then used in combination with a click probability to identify a ranking of an ad.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, ranking ads. As mentioned, the present invention seeks to utilize a reserve price directly into a ranking algorithm to rank/order ads. This provides the effect that ads with bids near a reserve price receive low rank scores relative to ads with high bids but lower click probabilities. This is in contrast to present uses of a reserve price where it is used simply as a minimum bid. This may be illustrated using the following equation:

(bᵢ−r)wᵢ Equation 1

where bᵢ is the bid submitted by the advertiser, r is the reserve price, and wᵢ is the click probability. Alternatively, wᵢ may be replaced with x, where x is a general quantity for an advertiser based, for example, on click through rate, quality, relevance, or the like.

This equation can be used to illustrate the benefits of incorporating the reserve price into the ranking algorithm. For sufficiently small reserve prices, it can be shown that this method raises more revenue than simply using the same reserve price purely as a filter. In other words, the change in revenue is due to the change in ordering (based on the reserve price) and not merely the introduction of the reserve price. The meaning of sufficiently small depends on the distribution of advertiser valuations, but for a number of natural distributions, it encompasses all choices of reserve price that do not exceed the revenue-optimal reserve.

Accordingly, in one embodiment, the present invention is directed to one or more computer-storage media having computer-executable instruction embodied thereon that, when executed by one or more computing devices, perform a method of ranking ads. The method comprises, identifying one or more advertisements in an auction; calculating a score for each of the one or more advertisements using a reserve price; and ranking the one or more advertisements using the score calculated utilizing the reserve price.

In another embodiment, the presented invention is directed to a computer system for ranking ads. The system comprises one or more processors coupled to a computer storage medium, the computer storage medium having stored thereon a plurality of computer software components executable by the processor, the computer software components comprising: a calculating component for calculating a score for each of one or more advertisements associated with a search query, wherein the score is calculated based on a reserve price; a ranking component for ranking the one or more advertisements based on the score for each of the one or more advertisements, wherein the score utilizes the reserve price; and a pricing component for associating a price with each of the one or more advertisements based on the score.

In yet another embodiment, the present invention is directed to one or more computer-storage media having computer-executable instruction embodied thereon that, when executed by one or more computing devices, perform a method of ranking ads. The method comprises receiving a search query; identifying one or more advertisements associated with the search query that are included in an auction for the search query; calculating a score for each of the one or more advertisements using each of a bid submitted for each of the one or more advertisements, a reserve price, and a click probability associated with each of the one or more advertisements; ranking the one or more advertisements based on the score calculated from the bid, the reserve price, and the click probability; and associating a price with each of the one or more advertisements based on the score.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIGS. 2-10 depicts exemplary sets of comparison tables in accordance with an embodiment of the present invention;

FIG. 11 is a block diagram of an exemplary system for ranking ads suitable for use in implementing embodiments of the present invention;

FIG. 12 is a flow diagram of an exemplary method of ranking ads in accordance with an embodiment of the present invention; and

FIG. 13 is a flow diagram of an exemplary method of ranking ads in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, ranking ads. The present invention is directed to utilizing a reserve price directly into a ranking algorithm to rank/order ads. This provides the effect that ads with bids near a reserve price receive low rank scores relative to ads with high bids but lower click probabilities. This is in contrast to present uses of a reserve price where it is used simply as a minimum bid.

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, an advertisement publisher service, an advertiser service, a Web browser, a cloud server, a set of one or more processes distributed on one or more computers, one or more stand-alone storage devices, a set of one or more other computing or storage devices, a combination of one or more of the above, and the like.

As previously mentioned, certain tradeoffs may be made when ranking ads. In order to examine the necessary tradeoffs, a solution concept that describes the outcome expected is used. The standard analysis of GSP auctions looks at complete information Nash equilibria, and in particular their refinement to symmetric or locally envy free Nash equilibria (SNE). However, the standard approach to analyzing the revenue of auction designs examines performance in Bayes-Nash equilibria.

Fortunately, it turns out that it is not necessary to choose between these two solution concepts. In a striking result, several groups of authors independently showed that, when ads are ranked by their bid multiplied by their click probability, the “lowest” SNE corresponds to the—VCG (Vickrey-Clark-Groves Auction) outcome. It has been shown that this continues to hold when these “rank scores” are multiplied by individualized weights, except that rather than VCG the results correspond to the outcome of a truthful mechanism they call the “laddered auction.” As this is a single parameter domain, this mechanism is a special case of Myerson's general technique for transforming a monotone allocation rule into a truthful mechanism.

The proposed new ranking algorithm is inspired by features of the revenue-optimal auction with provably good properties. Rather than using a reserve price simply as a minimum bid, it is incorporated directly into the ranking algorithm such that ads with bids near the reserve price receive low rank scores relative to ads with high bids but lower click probabilities. This change from {bᵢwᵢ} achieves a similar “squashing” effect to introducing an exponent α<1 and ranking by {bᵢwᵢ^{α}}. Hence both squashing and setting a reserve are achieved through a single parameter, as opposed to the effects being decoupled into a squashing exponent and a reserve.

Various simulations are discussed to illustrate the advantages of the new ranking algorithm. The following are preliminary statements for the simulations: (1) a standard (Bayesian) model of a GSP auction is adopted; (2) there are n advertisers (bidders) and m slots; (3) if bidder i's ad is displayed in slot k, its click-through rate (CTR) is wᵢsₖ. sₖ is a slot effect, while wᵢ is an ad effect and can be interpreted as the relevance of bidder i's ad. The slots are strictly heterogeneous, with effects s₁>s₂> . . . ; (4) advertiser i has value θᵢ for a click, values are i.i.d. with cdf F(θᵢ) and pdf f(θᵢ); (5) advertisers are assigned to slots by a ranking algorithm, this can be represented by a ranking function y(b,w)≧0, the advertisers are sorted by y(bᵢ,wᵢ) with the highest score receiving the first slot, advertisers with y(bᵢ,wᵢ)=0 are excluded (e.g. if they are below some reserve), y is restricted to be a monotone function with respect to b, but not necessarily w; (6) advertisers pay the generalised second price for their slot, assuming for simplicity that advertisers are ordered such that advertiser i is in slot i, advertiser i's payment is the minimum bid needed to keep his slot;

Pᵢ^{y}(bᵢ+1,wᵢ+1;wᵢ)=inf{b:y(bᵢwᵢ)>y(bᵢ+1,wᵢ+1)}. (2.1)

Continuing with the preliminary statements, (7) the possibility of non-trivial ties (i.e., y(bᵢwᵢ)=y(bⱼ,wⱼ)>0) are ignored as they complicate analysis, and it is not clear how ties should be resolved in a GSP auction. The analysis focuses on performance in expectation, and so this oversight is justified by noting that for all the considered ranking functions, non-trivial ties occur with probability zero and have no bearing on any expected quantity. (8) In the analysis it is helpful to refer to the slot effect sₖ assigned to advertiser i as his allocation xᵢ, in some instances it is appropriate to consider this a function of the realization of advertiser types: xⱼ(θ,w), if a ranking function y(b,w) is used to assign the slots, then it is appropriate to consider an advertiser's allocation as a function of the bid and relevance vectors, which is written as xᵢ^{y}(b,w). Lastly, (9) x or x^{y} is used to denote an allocation rule, which comprises the set of allocation functions {xᵢ} (or {xᵢ^{y}}).

Much of the theoretical work utilizes virtual values, a common concept in economic theory. Under general conditions, an advertiser's virtual value may depend on both his true value and his relevance. However in the interests of an easier analysis it is assumed independence between these two variables, which defines an advertiser's virtual value also to be independent of his relevance:

$$ϕ ( {θ}_{i} ) = {θ}_{i} - \frac{1 - F ( {θ}_{i} )}{f ( {θ}_{i} )} \qquad ( 2.2 )$$

It is further assumed that the virtual value function is differentiable, and that the hazard rate f(θᵢ)/(1−F(θᵢ)) is non-decreasing, conditions which hold for numerous common distributions. Again, these assumptions are to accommodate an easier analysis.

In order to compare ranking algorithms, some assumptions are be made about bidder behavior. A useful starting point is to assume a Bayes-Nash equilibrium (BNE) in which each advertiser submits a bid maximizing his own benefit in expectation over the others' types and bids, and his own relevance. An advantage of working in the Bayesian setting is that Myerson's theory may be used to quickly calculate expected revenue R. In any BNE,

$$R = R ( x ) = 𝔼 [ {\sum }_{i = 1}^{n} ϕ ( {θ}_{i} ) {w}_{i} {x}_{i} ( θ , w ) ] , \qquad ( 3.1 )$$

where it is written R(x) instead of (R(x); f, w) to emphasize the dependence on the allocation rule x. Hence, using Equation 3.1 one can simply characterize the revenue-optimal auction. That is, it ranks advertisers by φ(θᵢ)wᵢ, excluding any advertiser with negative virtual value (i.e. the auction has a reserve price of r= θ̅ where φ( θ̅)=0). However, actually implementing this auction is unlikely to be feasible in practice. In particular, this simple form relies on the assumptions that bidders are symmetric, and that relevance and value are independent. Otherwise, virtual values (and hence the ranking and reserve price) depend on the identity and relevance of the bidder, which makes practical auction design difficult. Even if one could implement such a revenue-optimal auction, other considerations such as advertiser and user satisfaction would make doing so undesirable.

Instead, two qualitative features of the revenue-optimal auction are noted. First, it uses a reserve price. Second, bidders with values barely above the reserve price are very low in the rankings. This inspires the new ranking algorithm which ranks ads by {(bᵢ−r)wᵢ}. Note that under the new ranking algorithm the price paid for slot i is bᵢ₊₁(wᵢ₊₁/wᵢ)+r(1−wᵢ₊₁/wᵢ), which follows from Equation 2.1, assuming advertiser i is allocated slot i.

One specific Nash equilibrium shall be used to compare ranking algorithms. Because of the difficulties involved in a full Bayes-Nash analysis for the GSP auction, a commonly used alternative is to assume a symmetric Nash equilibrium (SNE), an ex-post equilibrium concept proposed independently by Varian and Edelman et al. A SNE requires the following inequalities to be satisfied:

(θᵢ−pᵢ^{y}(bᵢ₊₁,wᵢ₊₁;wᵢ))xᵢ≧(θᵢ−pᵢ^{y}(bⱼ₊₁,wⱼ₊₁;wᵢ))x for all i,j, (4.1)

where pᵢ^{y} is the GSP payment. Note that the SNE inequalities of Equation 4.1 are stronger than those that define an ex-post Nash equilibrium, which for j<i would replace the subscripts j+1 with j in the right hand side of Equation 4.1. Hence the set of SNE is a subset of the set of ex-post equilibria.

The striking result that was realized is that under the ranking algorithm {bᵢwᵢ} any SNE yields an efficient outcome, and furthermore there exists a SNE—known as the lowest or bidder-optimal SNE—in which advertisers' positions and payments are identical to those imposed by the VCG mechanism. A more general connection has been shown between the ranking algorithm {bᵢwᵢcᵢ} (where cᵢ is a positive constant) and the corresponding “laddered auction”, a family of truthful mechanisms. This result is important for a number of reasons. First, it provides a focal outcome from the space of possible SNE. Second, it creates a link between SNE behavior and the Bayesian setting. And last, it provides a natural lower bound on revenue, as every other SNE has a higher revenue. For any ranking function of the form

y(b,w)=(g(w)b−h(w))⁺, (4.2)

SNE always exist (g and h are arbitrary non-negative functions). Since y does not does not necessarily rank the best ad highest, the outcome is, in general, no longer efficient. However, it does respect y, in the sense that the ranking in all SNE is the same ranking that would be used if bidders reported their true values. Finally, the lowest SNE still has a very special structure. Recall that x^{y}(b,w)={xᵢ^{y}(b,w)} are the allocations that result from bids b and ranking function y. By Equation 4.2, x^{y}(b,w) is a monotone allocation rule. Therefore, there are unique payments that make x^{y} an ex-post direct revelation mechanism. The lowest SNE implements this mechanism in the exact same way that the standard ranking implements VCG. In particular, since ex-post direct revelation mechanisms are also BNE, this allows a concise characterization of the revenue in the lowest SNE.

### Theorem 4.1.

Consider a GSP auction subject to a ranking algorithm y(b,w) within the class (4.2). Note that for simplicity it is assumed that all bidders are ranked by the same algorithm y. However, the result still holds if each ranked using an individualized algorithm y from the class (4.2). This enables the result to apply to settings where, for example, the mechanism design incorporates other factors into the rank score. For any realization (θ,w), there exists a non-empty set of SNE and all SNE order bidders by y(θᵢ, wᵢ). Furthermore, the lowest (revenue) SNE, defined by

$$y ( {b}_{i} , {w}_{i} ) {x}_{i - 1} = {\sum }_{j \geq i} y ( {θ}_{j} , {w}_{j} ) ( {x}_{j} - {x}_{j} ) , \qquad ( 4.3 )$$

generates expected revenue

$$R ( {x}^{y} ) = 𝔼 [ {\sum }_{i = 1}^{n} ϕ ( {θ}_{i} ) {w}_{i} {x}_{i}^{y} ( θ , w ) ] . \qquad ( 4.4 )$$

PROOF. From the GSP payment rule (2.1), the price-per-click charged to bidder i is

$${p}_{i}^{y} ( {b}_{i + 1} , {w}_{i + 1} ; {w}_{i} ) = \frac{y ( {b}_{i + 1} , {w}_{i + 1} ) + h ( {w}_{i} )}{g ( {w}_{i} )}$$

The SNE inequalities (4.1) are then

$$( {θ}_{i} - \frac{y ( {b}_{i + 1} , {w}_{i + 1} ) + h ( {w}_{i} )}{g ( {w}_{i} )} ) {x}_{i} \geq ( {θ}_{i} - \frac{y ( {b}_{j + 1} , {w}_{j + 1} ) + h ( {w}_{i} )}{g ( {w}_{i} )} ) {x}_{j}$$

which is equivalent to

(y(θᵢ,wᵢ)−y(bᵢ₊₁,wᵢ₊₁))xᵢ≧(y(θᵢ,wᵢ)−y(bⱼ₊₁,wᵢ₊₁))xⱼ. (4.5)

Varian's analysis can be directly reapplied to this generalisation, leading to the conclusion that there exists a non-empty set of SNE, and furthermore all SNE use the same allocation rule, ordering bidders by y(θᵢ,wᵢ).
In the lowest SNE (4.3), advertiser i's payment pᵢ satisfies

$$\begin{matrix}y ( {p}_{i} , {w}_{i} ) = y ( {b}_{i + 1} , {w}_{i + 1} ) \\ = \frac{1}{{x}_{i}} {\sum }_{j \geq i + 1} y ( {θ}_{j} , {w}_{j} ) ( {x}_{j - 1} - {x}_{j} ) \\ = y ( {θ}_{i} , {w}_{i} ) - \frac{1}{{x}_{i}} {\sum }_{j \geq i} {x}_{j} ( y ( {θ}_{j} , {w}_{i} ) - y ( {θ}_{j + 1} , {w}_{j + 1} ) ) \\ = y ( {θ}_{i} , {w}_{i} ) - \frac{1}{{x}_{i}} {\int }_{0}^{{θ}_{i}} {x}_{i}^{y} ( t , {θ}_{- i} , w ) d y ( t , {w}_{i} ) .\end{matrix}$$

As dy(t,wᵢ)=g(wᵢ)dt,

$${p}_{i} = {θ}_{i} - \frac{1}{{x}_{i}} {\int }_{0}^{{θ}_{i}} {x}_{i}^{y} ( t , {θ}_{- i} , w ) d t ,$$

which precisely describes the payment functions imposed by the ex-post direct revelation mechanism for the allocation rule x^{y}(θ,w). Thus, the lowest SNE is also a BNE, and therefore generates expected revenue (4.4).

This generalisation of the lowest SNE to the class of rankings (4.2) includes ranking by bid {bᵢ}, by expected revenue {bᵢwᵢ}, and the squashed ranking {bᵢwᵢ^{α}}, all with a possible reserve score (i.e. a per-impression reserve). It also incorporates the new ranking algorithm with reserve price r (i.e. a per-click reserve).

Note, however, that the standard ranking algorithm {bᵢwᵢ} with reserve price r corresponds to the ranking function z(b, w)= [symbol] {b≧r}bw, which is not of the required form. This introduces some analytical complexities later when comparing the properties of the new ranking algorithm to this algorithm. While Theorem 4.1 guarantees SNE of ranking algorithms in the class (4.2) are well behaved, the same cannot be said of the standard ranking with a reserve price. In fact, this algorithm can be quite poorly behaved, in a sense that will be made clear later.

An additional justification of the focus on the lowest equilibrium is given. This justification has the additional benefit of applying even for rankings outside of the class (4.2), for which SNE may not exist, a feature exploited below. It has been argued that because SNE is a full information solution concept used to model the outcome of a game that is in reality one of incomplete information, one should only consider SNE that are in some sense “feasible” in the Bayesian setting. A term was defined called the Non-Contradiction Criteria (NCC), which deems a SNE implausible if it generates greater expected revenue than any BNE of the corresponding repeated game of incomplete information. Rather than characterising the BNE of the repeated game, the revenue of the optimal BNE was used as an upper bound. In that setting, this upper bound on revenue exactly matches the revenue of the lowest SNE, and therefore it is argued it is the only reasonable equilibrium.

In the setting of the present application, the revenue of the optimal BNE, while still an upper bound, does not necessarily match the revenue given by the lowest SNE of an arbitrary ranking algorithm of the form (4.2). However, it is known from Theorem 4.1 that given a ranking function y, all SNE share the same allocation rule x^{y}(θ, w). Therefore, a natural comparison is to BNE that also share the same allocation rule. Rather than characterising such equilibria, instead, an upper bound on their revenue was derived. Since the allocations have been fixed, Myerson's theory allows us to trivially derive such an upper bound.

PROPOSITION 4.2. Given a ranking function y, the optimal BNE that ranks ads by y(θᵢ, wᵢ) has expected revenue

$$R ( {x}^{y} ) = 𝔼 [ {\sum }_{i = 1}^{n} ϕ ( {θ}_{i} ) {w}_{i} {x}_{i}^{y} ( θ , w ) ] .$$

By Theorem 4.1, this upper bound exactly matches the revenue of the lowest SNE, providing additional justification for the decision to use it as a focal outcome of a GSP auction. Further, any method of selecting an SNE given types (θ, w) implicitly defines such a ranking function y, not necessarily within the class (4.2), so this upper bound remains useful even for ranking algorithms outside this class.

Next, the revenue generated by the new ranking algorithm {(bᵢ−r)wᵢ} is compared with the standard ranking {bᵢwᵢ}, both employing the same per-click reserve price r. This comparison is of particular interest as the two algorithms exclude the same set of advertisers, thus isolating the effect of incorporating the reserve price into the ranking function. It is found that for sufficiently small reserve prices, the new ranking algorithm generates greater revenue. While in practice the designer may not be solely interested in revenue, this result helps to show how the new ranking algorithm may offer favourable tradeoffs between revenue and welfare. That is, for a given target revenue, a designer using the new ranking algorithm needs to use a smaller (and thus less distortionary) reserve price than a designer employing the standard ranking.

The assumption of equilibrium behaviour in GSP auctions to be SNE whose revenue does not exceed the bound in Proposition 4.2 is used. For the new proposed ranking algorithm {(bᵢ−r)wᵢ)} this is equivalent to taking the lowest SNE. However, the standard ranking algorithm {bᵢwᵢ} with reserve price r has the corresponding ranking function z(b, w)= [symbol] {b≧r} bw, which is not within the class (4.2). With this ranking algorithm, it is not certain whether or not a SNE is guaranteed to exist. An example showing that any SNE that does exist cannot always rank ads by θᵢ wᵢ is given. That is, ads do not necessarily appear in the desired order. For the standard ranking algorithm with a reserve price (i.e. z(b, w)= [symbol] {b≧r} bw), this example shows that a SNE cannot always rank ads by z(θᵢ,wᵢ), in contrast to SNE under ranking algorithms within the class (4.2). The SNE inequalities (4.1) can be written as

(θᵢwᵢ−max{rwᵢ,bᵢ₊₁wᵢ₊₁})xᵢ≧((θᵢwᵢ−max{rwᵢ,bⱼ₊₁wⱼ₊₁})xⱼ) (A.1)

Consider the following realization: There are precisely two advertisers who submit qualifying bids (bᵢ≧r), with bidder 1 being awarded the top slot and bidder 2 the second (b₁w₁>b₂w₂ and x₁>x₂). Bidder 1 is less relevant (w₁<w₂). Suppose a SNE always ranks ads by z(θᵢ, wᵢ), so that θ₁w₁≧θ₂w₂. The bids (b₁, b₂) must satisfy the inequalities

(θ₁w₁−max{rw₁,b₂w₂})x₁≧(θ₁w₁−rw₁)x₂, (A.2)

(θ₂w₂−rw₂)x₂≧(θ₂w₂−max{rw₂,b₂w₂})x₁. (A.3)

It is necessary that b₂>r in order to satisfy (A.3), and as w₁<w₂, max{rw₁, b₂w₂}=max{rw₂, b₂w₂}=b₂w₂. Then inequalities (A.2) and (A.3) can be rewritten:

b₂w₂x₁≦θ₁w₁(x₁−x₂)+rw₁x₂, (A.4)

b₂w₂x₁≧θ₂w₂(x₁−x₂)+rw₂x₂, (A.5)

The RHS of (A.4) needs to be at least as large as the RHS of (A.5). However, this is not always the case. For example, suppose (θ₁, w₁)=(1, 0.7), (θ₂, w₂)=(0.6, 1), r=0.5, and (x₁, x₂)=(1, 0.5). The bounds on advertiser 2's bid are found to be b₂≧0.55 and b₂≦0.525. Thus, a SNE under the standard ranking algorithm with a reserve price does not necessarily rank ads by θᵢwᵢ.

Despite the complexity of behaviour with this ranking algorithm, the following theorem is presented which states that, for sufficiently small reserve prices, the lowest SNE of the GSP auction subject to the new ranking {(bᵢ−r)wᵢ} generates greater expected revenue than any SNE under the standard ranking {bᵢwᵢ} (with the same reserve price r) that respects the revenue upper bound from Proposition 4.2.

THEOREM 5.1. For rε(0, \hat{θ}], define R₁(r) and R₂(r) to be the expected revenues from two allocation rules that select outcomes that are SNE and do not exceed the bound from Proposition 4.2 under the ranking algorithms {(bᵢ−r)wᵢ} and {bᵢwᵢ} respectively. If

$$r \leq \begin{matrix}inf \\ t \geq r\end{matrix} \{ t - \frac{ϕ ( t )}{{ϕ}^{′} ( t )} \} , \qquad ( 5.1 )$$

then R₁(r)>R₂ (r).

Informally, condition (5.1) seems to hold for most reasonable distributions and for most rε(0, \hat{θ}). More precisely, it will hold for all rε(0, \hat{θ}) when φ(θᵢ) is weakly convex. It is straightforward to show that sufficient conditions for φ(θᵢ) to be weakly convex are that f is log-concave and non-increasing. Log-concavity is a property of many common distributions and is a standard assumption in economic analysis. Requiring f to be non-increasing is somewhat restrictive, but permits, for example, the uniform or exponential distribution. Conversely, If φ(θᵢ) is concave then it is likely that condition (5.1) does not hold for some choices of r. For example, consider θᵢ˜Beta(2, 2) which has a monotone hazard rate and defines φ(θᵢ) to be concave. In this case θ̅=0.4215, and for all r the RHS of (5.1) is minimised at t=1 to the value ⅓. Thus, there exists an interval (⅓, θ̅) in which r does not satisfy condition (5.1).

For choices of r that do not satisfy condition (5.1), it does not follow that the new ranking algorithm therefore generates less revenue than the standard. On the contrary, it is expected that the new ranking algorithm generates more revenue in most cases. To give an intuitive explanation, proof of Theorem 5.1 involves showing that one can apply a large number of pairwise allocation swaps to transform the allocation rule arising from the standard ranking to that of the new ranking, each of which increases revenue. If r is slightly greater than the RHS of (5.1) then a small proportion of swaps will decrease revenue, while most will still cause an increase. In many such cases, the net result will still be a revenue increase. Such behaviour is seen in simulations given below.

Theorem 5.1 is worked up to through a series of lemmas. As previously mentioned, the upper bound from Proposition 4.2 is well defined for arbitrary monotone allocation rules. Let R(x) be the value of this bound for the allocation rule x:

$$R ( x ) = 𝔼 [ {\sum }_{i = 1}^{n} ϕ ( {θ}_{i} ) {w}_{i} {x}_{i} ( θ , w ) ] . \qquad ( 5.2 )$$

If x is not monotone then Proposition 4.2 no longer holds, however R(x) is still well defined as the same functional form. The only difference in this case is that R(x) does not translate as an achievable revenue. The first lemma shows how one can increase the integrand of (5.2) for a given realisation (θ, w). This is achieved by performing a simple adjustment or swap to the allocation rule x.

LEMMA 5.2. Suppose x is an allocation rule for which there exists a realisation (θ, w) and specific i,j such that

φ(θᵢ)wᵢ>φ(θⱼ)wⱼ,

xᵢ(θ,w)<xⱼ(θ,w)

Define the adjusted allocation rule \tilde{x} which is identical to x except for the single swap \tilde{x}ᵢ(θ, w)=xⱼ(θ, w) and vice versa. Then,

$${\sum }_{i = 1}^{n} ϕ ( {θ}_{i} ) {w}_{i} {\tilde{x}}_{i} ( θ , w ) > {\sum }_{i = 1}^{n} ϕ ( {θ}_{i} ) {w}_{i} {x}_{i} ( θ , w )$$

PROOF. Direct from the conditions.

The next lemma follows as a corollary to Lemma 5.2, extending it to situations where improvements are possible through a sequence of swaps.

LEMMA 5.3. Let x^{y} and x^{z} be two allocation rules such that the following properties hold for all θᵢ, wᵢ, θⱼ, wⱼ:

y(θᵢ,wᵢ)=0 [symbol] z(θᵢ,wᵢ)=0, (5.3)

{y(θᵢ,wᵢ)>y(θⱼ,wⱼ) AND z(θᵢ,wᵢ)<z(θⱼ,wⱼ)} [symbol] φ(θᵢ)wᵢ>φ(θⱼ)wⱼ. (5.4)

Then, R(x^{y})≧R(x^{z}). Furthermore, if x^{y} and x^{z} differ with positive probability then R(x^{y})>R(x^{z}).

The intuition behind Lemma 5.3 is clear—if it holds that any time y and z disagree about the ranking of two advertisers then y is ‘correct’, then it should hold that R(x^{y})>R(x^{z}). The proof involves showing that one can perform a sequence of swaps to transform x^{y} into x^{z}, where each swap satisfies the conditions of Lemma 5.2.

Given a realisation (θ, w), suppose there are k advertisers who receive positive scores. Take the labelling of advertisers:

y(θ₁,wᵢ)>y(θ₂,w₂)> . . . >y(θₖ,wₖ)

xᵢ^{y}(θ,w)≧x₂^{y}(θ,w)≧ . . . ≧xₖ^{y}(θ,w). (B.3)

Recall that previously the assumption was made of strict heterogeneity of slot effects (s₁>s₂> . . . ). The weak ordering in (B.3) was specified because the number of available slots may be less than k. However, if advertiser i receives a positive allocation then the strict inequality xᵢ^{y}>xᵢ₊₁^{y} holds. From now on the shorthand notation y(θ₁, w₁)=y₁, x₁^{y}(θ, w)=x₁^{y} etc will be used. Let Γ be the permutation of indices such that

zᵣ₍₁₎>zᵣ₍₂₎> . . . >zᵣ₍ₖ₎

xᵣ₍₁₎^{z}≧ . . . ≧xᵣ₍ₖ₎^{z}.

That is, if an advertiser has the i'th highest score w.r.t. z, he has the Γ(i)'th highest score w.r.t. y. It is necessary to show that F can be reordered through a sequence of swaps, each of which either satisfies the conditions of Lemma 5.2, or is a trivial swap. Let S be the set of inversions

S={(Γ(i),Γ(j)):i<j and Γ(i)>Γ(j)}.

Using the fact that Γ (and Γ⁻¹) can be decomposed into a product of |S| adjacent transpositions, where each transposition resolves precisely one of the inversions in S. Applying such a decomposition to the allocations x^{z}, each non-trivial swap resolves some inversion (Γ(i), Γ(j)). Note that

zᵣ₍ᵢ₎>zᵣ₍ⱼ₎ as i<j.

yᵣ₍ᵢ₎<yᵣ₍ⱼ₎ as Γ(i)>Γ(j)

φ(θᵣ₍ᵢ₎)wᵣ₍ᵢ₎<φ(θ_{Γ(j)})w_{Γ(j)} as (5.4) holds.

x_{Γ(i)}>x_{Γ(j)} as the inversion has not been previously resolved, and the swap is nontrivial.

By the repeated application of Lemma 5.2, given an arbitrary realisation (θ, w) at which the allocation rules x^{y} and x^{y} differ,

$${\sum }_{i = 1}^{n} ϕ ( {θ}_{i} ) {w}_{i} {x}_{i}^{y} ( θ , w ) {\sum }_{i = 1}^{n} ϕ ( {θ}_{i} ) {w}_{i} {x}_{i}^{z} ( θ , w )$$

This process can be applied to all realisations, showing that R(x^{y})≧R(x^{z}) pointwise. Furthermore, if x^{y} and x^{z} differ with positive probability then R(x^{y})>R(x^{z}).
The third lemma is the heart of the proof. It shows that for a sufficiently small reserve price r, the two ranking functions defined by the new ranking algorithm and the standard satisfy conditions (5.3) and (5.4) from the previous lemma.

LEMMA 5.4. Given a reserve price rε(0, θ̅) let

y(θᵢ,wᵢ)=(θᵢ−r)+wᵢ, (5.5)

z(θ₁,wₜ)= [symbol] {θᵢ≧r}θᵢwᵢ. (5.6)

### If

$$r \leq \begin{matrix}inf \\ t \geq r\end{matrix} \{ t - \frac{ϕ ( t )}{{ϕ}^{′} ( t )} \} , \qquad ( 5.7 )$$

then R(x^{y})>R(x^{z}).
The proof of Lemma 5.4 involves showing that conditions (5.3) and (5.4) are satisfied. Proof is provided below:
Consider two advertisers i and j where θᵢ>θⱼ≧r. Using the shorthand notation φ(θᵢ)=φᵢ, the ratio of their virtual values is written as

$$\frac{{ϕ}_{i}}{{ϕ}_{j}} = \frac{{θ}_{i} - g ( {θ}_{i} , {θ}_{j} )}{{θ}_{j} - g ( {θ}_{i} , {θ}_{j} )} ,$$

where

$$g ( {θ}_{i} , {θ}_{j} ) = \frac{{θ}_{j} {ϕ}_{i} {θ}_{i} {ϕ}_{j}}{{ϕ}_{i} - {ϕ}_{j}} . \qquad ( C .4 )$$

Note that

$$\frac{\partial }{\partial k} ( \frac{{θ}_{i} - k}{{θ}_{j} - k} ) = \frac{{θ}_{i} - {θ}_{j}}{( {θ}_{j} - k )} > 0.$$

If r≦g(θᵢ,θⱼ),

$$\frac{{θ}_{i}}{{θ}_{j}} < \frac{{θ}_{i} - r}{{θ}_{j} - r} \leq \frac{{ϕ}_{i}}{{ϕ}_{j}} .$$

In this case the following properties hold:

$$\begin{matrix}\{ \frac{{θ}_{i} - r}{{θ}_{j} - r} > \frac{{w}_{j}}{{w}_{i}} AND \frac{{θ}_{i}}{{θ}_{j}} < \frac{{w}_{j}}{{w}_{i}} \} \frac{{ϕ}_{i}}{{ϕ}_{j}} > \frac{{w}_{j}}{{w}_{i}} , & ( C .5 ) \\ \frac{{θ}_{i} - r}{{θ}_{j} - r} < \frac{{w}_{j}}{{w}_{i}} \frac{{θ}_{i}}{{θ}_{j}} < \frac{{w}_{j}}{{w}_{i}} & ( C .6 )\end{matrix}$$

It is desirable to find under what conditions r≦g(θᵢ, θⱼ) for all θᵢ>θⱼ≧r.

Denote the upper bound of the range of θᵢ by T (possibly infinite), and consider the infimum of g(θᵢ, θⱼ). It's argued that this must occur either at one of the limit points as θⱼ→θᵢ, for some θᵢε[r,T], or at (θᵢ, θⱼ)=(T,r). Consider the minimising value of θᵢ given a fixed θⱼ=t. This is either (a) at θᵢ=T, (b) at some θᵢε[t,T], or (c) at the limit as θᵢ→t. In case (b), ∂g/∂θᵢ=0 as g is continuous. From (C.4) this is equivalent to

$${{ϕ}^{′}}_{i} = \frac{{ϕ}_{i} - ϕ ( t )}{{θ}_{i} - t} ,$$

in which case g can be rewritten as

$$g ( {θ}_{i} , t ) = {θ}_{i} - \frac{{ϕ}_{i}}{{{ϕ}^{′}}_{i}} = \begin{matrix}lim \\ {θ}_{j} -> {θ}_{i}\end{matrix} g ( {θ}_{i} , {θ}_{j} )$$

Thus in both cases (b) and (c), the infimum of g(θᵢ, t) with respect to t is some limit point of g(θᵢ, θⱼ) as θⱼ→θᵢ. A similar argument can be made regarding the minimising value of θⱼ given a fixed θᵢ, leading us to the conclusion that the infimum value of g(θᵢ, θⱼ) must occur either (i) at one of the limit points as θⱼ→θᵢ. or (ii) at (θᵢ, θⱼ)=(T,r) In case (ii)

r≦ θ̅ [symbol] φ(r)≦0 [symbol] r≦inf{g(θᵢ,θⱼ)}

In case (i), one requires condition (5.7) to obtain r≧inf{g(θᵢ, θⱼ)}.

Therefore, if (5.7) holds then r≦g(θᵢ, θⱼ) for all θᵢ>θⱼ≧r Then properties (C.5) and (C.6) imply (5.4) holds and one can invoke Lemma 5.3 to show R(x^{y})≧R(x^{z}). Furthermore, as θᵢ has continuous support over its range, the allocation rules x^{y} and x^{z} must differ with positive probability, implying R(x^{y})>R(x^{z}).

The only remaining technical detail is that the ranking function z(b, w)= [symbol] {b≧r} bw is not within the class (4.2). As previously discussed, this means one needs to consider the possibility that there may exist SNE with a different ranking from z(θᵢ, wᵢ), to which one cannot directly apply the upper bound R(x^{z}). However, the final lemma shows that any such alternate rankings can only reduce the upper bound on revenue.

LEMMA 5.5. Let x be an allocation rule that selects a SNE of a GSP auction with the ranking function z(b, w)= [symbol] {b≧r} bw. Then R(x^{z})≧R(x).

Given a realization (θ, w), suppose the allocation rule x selects the SNE in which advertiser i bids bᵢ(θ, w). One can make the following intuitive assumptions about advertisers' bidding strategies:

θᵢ≧r [symbol] r≦bᵢ≦θᵢ (1)

xᵢ=0 [symbol] bᵢ=θᵢ (2)

Assumption 1 makes sense as if θᵢ≧r, then bᵢ=r is a dominant strategy over bᵢ<r and bᵢ=θᵢ is dominant over bᵢ>θᵢ. Assumption 2 is a little less intuitive, but is a common concept in auction theory—that is, any losing bidder submits the maximum bid without exposing himself to the possibility of a loss, which is clearly a (weakly) dominant strategy and further drives competition in the auction. Assumptions 1 and 2 imply

z(θᵢ,wᵢ)=0 [symbol] z(bᵢ,wᵢ)=0 (D.1)

Suppose there are k qualifying advertisers (θᵢ,bᵢ≧r). Take the labelling of advertisers such that

b₁w₁>b₂w₂> . . . >bₖwₖ

x₁≧x₂≧ . . . ≧xₖ.

Consider any realisation at which the allocation rules x and x^{z} differ. That is, there exists a pair of advertisers j<i such that bⱼwⱼ>bᵢwᵢ,θⱼwⱼ<θᵢwᵢ, and xⱼ>xᵢ. From the SNE inequalities (A.1):

(θⱼwⱼ−max{rwⱼ,bⱼ₊₁wⱼ₊₁})xⱼ≧(θⱼwⱼ−max{rwⱼ,bᵢwᵢ})xᵢ (D.2)

(θᵢwᵢ−max{rwᵢ,bⱼ₊₁wⱼ₊₁})xⱼ≦(θᵢwᵢ−max{rwᵢ,bᵢ₊₁wᵢ₊₁})xᵢ (D.3)

Taking (D.3) away from (D.2):

(θⱼwⱼ−θᵢwᵢ)(xⱼ−xᵢ)≧max{rwᵢ,bᵢ₊₁wᵢ₊₁}−max{rwᵢ,bⱼ₊₁wⱼ₊₁}+max{rwⱼ,bⱼ₊₁wⱼ₊₁}−max{rwⱼ,bᵢ₊₁wᵢ₊₁}

As xⱼ>xᵢ and θⱼwⱼ<θᵢwᵢ, the LHS (and thus the RHS also) is negative. In the interest of brevity, denote the four terms in the RHS by A, B, C, and D respectively. One knows C≧D (as bⱼ₊₁wⱼ₊₁>bᵢ₊₁wᵢ₊₁), thus it is necessary that A<B. This implies B=bⱼ₊₁wⱼ₊₁ as A≧rwᵢ. This implies C≧B, and thus it is necessary that A<D. This implies D=rwⱼ as A≧bᵢ₊₁wᵢ₊₁. Now:

RHS=max{rwᵢ,bᵢ₊₁wᵢ₊₁}−bⱼ₊₁wⱼ₊₁+max{rwⱼ,bⱼ₊₁wⱼ₊₁}−rwⱼ=max{rwᵢ,bᵢ₊₁wᵢ₊₁}−min{rwⱼ,bⱼ₊₁wⱼ₊₁}

For this to be negati it is necessary that rwⱼ>rwᵢ and thus wⱼ>wᵢ. As θⱼwⱼ<θᵢwᵢ, θⱼ<θᵢ is needed. As the hazard rate f(θᵢ)/(1−F(θᵢ)) is non-decreasing,

$$\frac{1 - F ( {θ}_{i} )}{f ( {θ}_{i} )} \leq \frac{1 - F ( {θ}_{j} )}{f ( {θ}_{j} )}$$

$$\frac{1 - F ( {θ}_{i} )}{f ( {θ}_{i} )} {w}_{i} \leq \frac{1 - f ( {θ}_{j} )}{f ( {θ}_{j} )} {w}_{j}$$

Taking this inequality away from θᵢwᵢ>θⱼwⱼ, we get φ(θᵢ)wᵢ>φ(θⱼ)wⱼ. Thus,

{θᵢwᵢ>θⱼwⱼ AND bᵢwᵢ<bᵢwᵢ<bⱼwⱼ} [symbol] φ(θᵢ)wᵢ>φ(θⱼ)wⱼ. (D.4)

Note that (D.4) coupled with (D.1) closely resemble the properties (5.3) and (5.4) required for Lemma 5.3. Indeed, one can follow the same process described above and show that R(x^{z})≧R(x). The addition of Lemma 5.5 is sufficient to complete proof of Theorem 5.1. By Theorem 4.1, R₁(r)=R(x^{y}); by Lemma 5.4, R(x^{y})>R(x^{z}); and by Lemma 5.5, R(x^{z})≧R₂ (r). Thus one is left with R₁(r)>R₂ (r).

The simulations are now used to examine the performance of the new ranking algorithm and show that it generally dominates existing ranking algorithms. Three metrics are examined: revenue, welfare, and click yield. Revenue is what the auctioneer cares about (at least in the short term). Welfare is the total value created for advertisers (Σθᵢwᵢxᵢ), and the auctioneer also cares about this for the long-term health of the platform. Similarly, click yield (i.e. the total number of clicks Σwᵢxᵢ) can be thought of as a proxy for the value created for the users who are clicking on (presumably) useful ads.

There is a technical detail relevant to FIGS. 2-7. As previously discussed, the standard ranking algorithm coupled with a reserve price r corresponds to the ranking function z(b, w)= [symbol] {b≧r} bw, which is not within the class (4.2). As a consequence, any existing SNE may not be well-behaved. Instead of trying to characterise such equilibria, the relevant statistics of the optimal BNE which ranks ads by z(θᵢ, wᵢ) are used. By Lemma 5.5, the BNE revenue R(x^{z}) is an upper bound for the corresponding SNE revenue. Thus, the curves may display overestimates of the true revenues.

A simple example is now given, which satisfies the distributional assumptions made above. There are eight advertisers bidding for three slots. Advertisers have i.i.d. types (θᵢ, wᵢ) where θᵢ and wᵢ are independent and both uniformly distributed on [0,1]. FIG. 2 illustrates Theorem 5.1 in this setting: for all r≦0.5 (= θ̅), the new ranking algorithm of incorporating the reserve price into the ranking function raises more revenue than the standard ranking. In this simple setting, the optimal revenue at r=0.5 can be achieved.

However, Theorem 5.1 does not indicate what the cost of this added revenue is in terms of welfare. FIG. 3 shows that this revenue is essentially free: for any welfare desired, more revenue can be achieved with the proposed ranking algorithm. Note that this does not mean that with the same reserve price the new ranking algorithm is more efficient. Instead, if separate reserve prices are chosen such that both algorithms have the same welfare, the new ranking algorithm has higher revenue.

In FIG. 3, performance is compared against a squashed ranking algorithm with reserve score ρ (i.e. y(b, w)=(bw^{α}−ρ)⁺). Since there are two parameters, the operating points form the entire shaded region. The new ranking algorithm leads to a set of operating points that dominates this algorithm as well. Two special cases of this ranking algorithm are the squashing ranking algorithm with no reserve (ρ=0) and the standard ranking algorithm with a reserve score (α=1). The latter is particularly interesting to compare to the standard ranking algorithm with a reserve price. It was observed that for identical pre-reserve rankings, the addition of a reserve price dominates the alternative option of a reserve score. Despite the fact that the plotted revenues of the standard ranking with a reserve price may be overestimates, this still suggests that it is generally better to use reserve prices than reserve scores. FIG. 4 shows that these results do not change if one examines click yield rather than welfare.

Lahaie and Pennock examined the performance of the squashed ranking in a more realistic setting, which they selected by fitting gathered data from a particular query. This distribution violates several of the previously identified assumptions. Bidder valuations have a lognormal distribution, which does not have a monotone hazard rate. Values are also correlated with relevance. Nevertheless, FIGS. 5-7 show that the results from the simple setting are essentially unchanged, with the new ranking algorithm incorporating a reserve price into the ranking function offering superior tradeoffs.

Finally, all of these results are based on the assumption that bidders are in equilibrium. In reality, if parameters are changed, the algorithm may take some time to reach the new equilibrium, and there is empirical evidence that some advertisers react quite slowly to changes. Therefore, a natural question is what happens when the ranking algorithm is changed but advertisers do not react? If the short-term effect is revenue-positive or revenue-neutral, it is much easier for the auctioneer to be patient. Furthermore, by not requiring an equilibrium analysis, one can examine the performance of different ranking algorithms on historical data, which has many realistic features not captured by the simple model (e.g. changing bidders, matching of bids to multiple queries, and stochastic quality scores).

FIG. 8 shows the effect on revenue of changing from the standard ranking algorithm to the new ranking algorithm while keeping the reserve price fixed based on historical data for a keyword with over 500 bidders, which were selected as representative of a “thick” market. The data has been normalized, but the exact values are not relevant in the instant discussion. In such markets, incorporating the reserve price into the ranking function seems to consistently increase revenue.

FIG. 9 is a similar plot of a “thin” market with fewer than 10 bidders. Here, at certain values, the standard ranking raises somewhat more revenue. The included histogram of bid frequencies suggests an explanation for this: setting the reserve price at a common bid makes those bidders pay their full value, while the standard ordering ranks them highly to extract as much revenue as possible. In practice, such reserve prices are unlikely to be chosen, as setting a reserve price to match common bids would essentially make that auction first price, as well as being very sensitive to small changes in bid. At more reasonable choices of reserve price, the new ranking algorithm of incorporating it into the ranking function yields greater revenue.

FIGS. 8 and 9 also demonstrate several advantages of the new ranking algorithm from an optimisation perspective. First, the solid lines are “smoother”, which creates a somewhat easier problem. Second, the fact that bidders near the reserve price have low rank scores means that the revenue from an advertiser begins to decrease before the reserve price is actually raised past his bid. This reduces the tendency of optimisation to overfit and choose a reserve price directly below an advertiser's bid.

To examine the tradeoff between revenue and click yield, a subset of the ranking algorithms using global parameter settings on a sample of a week's worth of data across all queries was tested. In this example, there is a minimum bid of 5 cents in the actual system, so there is an implicit reserve price of 5 cents applied to all ranking algorithms in addition to any other parameters. FIG. 10 shows that incorporating the reserve price into the ranking function results in a better tradeoff than using the reserve price solely as a minimum bid. As in the single query case, the standard ranking experiences bigger peaks and drops as the reserve price approaches common bids (in this figure increasing the reserve corresponds to moving right to left). Interestingly, a reserve score does not generate a useful tradeoff (at least when set globally) as increasing it reduces both revenue and clicks. Any gains from raising the price the last ad shown pays are more than offset by the lower number of clicks.

Ostrovsky and Schwarz presented results of a field experiment aimed at testing the effects of employing Myerson's optimal reserve price in GSP auctions. Historical bid data for a large number of queries was used to estimate distributions of advertisers' values and subsequently optimal reserve prices. After employing the new reserve prices, they observed substantial increases in revenue. However, their reserves were implemented as minimum scores and were not used to change to ordering of ads.

Referring now to FIG. 11, a block diagram is provided illustrating an exemplary computing system 1100 in which embodiments of the present invention may be employed. Generally, the computing system 1100 illustrates an environment where reserve price is utilized to rank ads. Among other components not shown, the computing system 1100 generally includes a user device 1102, a data store 1104, a network 1106 and a ranking engine 1108. It is understood and appreciated by those of ordinary skill in the art that the computing system architecture 1100 shown in FIG. 11 is merely an example of one suitable computing system and is not intended to suggest any limitation as to the scope of use or functionality of the embodiments of the invention. Neither should the computing system architecture 1100 be interpreted as having any dependency or requirement related to any single module/component or combination of modules/components illustrated therein.

The various components of the computing system architecture 1100 are connected to each other and in communication with one another via the network 1106. The network 1106 may include, without limitation, one or more local area networks (LANs) and/or wide area networks (WANs). Such networking environments are commonplace in offices, enterprise-wide computer networks, intranets and the Internet. Accordingly, the network 1106 is not further described herein.

Each of the user device 1102 and the ranking engine 1108 shown in FIG. 11 may be any type of computing device, such as, for example, computing device 100 described above with reference to FIG. 1. By way of example only and not limitation, each of the user device 1102 and the ranking engine 1108 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof. The ranking engine 1108 may also include any type of device configurable to perform methods described herein.

Components of the ranking engine 1108 may include a calculating component 1110, a ranking component 1120, a pricing component 1130, and a displaying component 1140. Initially, it is noted that the computing system architecture 1100 may be configured to operate on a real-time basis or at any other time deemed appropriate to an administrator. For instance, the ranking engine 1108 may be utilized to rank one or more ads on a real-time basis as a search query is received or it may rank one or more ads to store in the data store 1104 for later use.

The calculating component 1110 is configured for, among other things, calculating a score for one or more ads. The calculating component 1110 may calculate the score in a variety of ways. In an embodiment, the calculating component 1110 calculates the score using Equation 1, listed above. In other words, the calculating component 1110 calculates the score based on a bid submitted for an ad by an advertiser, a click probability for the ad, and a reserve price. A reserve price, as used herein, refers generally to a minimum bid that is be made in order to be considered for ad placement. For instance, an exemplary reserve price may be $0.05. Thus, advertisers must bid at least $0.05 to be considered to have their ad displayed. By considering the reserve price in the calculation low bids submitted by advertisers are, in essence, penalized as they are not going to be ranked as high as ads associated with high bids.

The ranking component 1120 is configured for, among other things, ranking one or more ads. The ranking component 1120 may rank the one or more ads based on the score calculated by, for instance, the calculating component 1110. The ads may be ranked in any way desired by an administrator. In an embodiment, the ads are ranked by the ranking component 1120 from the highest ranking ad to the lowest ranking ad. As the ads are ranked based on the score calculated by the calculating component 1110, the ads are essentially be ranked, or ordered, utilizing the reserve price.

The pricing component 1130 is configured for, among other things, establishing a price to be paid by, for example, an advertiser. Once a score is calculated for one or more ads and the one or more ads are ranked based on their scores, it is determined which ad is the “winner” and what price should be associated with the ad. In a GSP auction, advertisers may not end up paying what they bid. Rather, in a GSP auction, the auction winner pays only a minimum bid necessary in order to maintain the win. For example, if Advertiser A bid $5.00 and was determined to be the winner of the auction but only a bid of $4.33 was necessary to maintain the win, Advertiser A will only pay $4.33. Thus, the pricing component 1130 identifies a price that to be associated with each ad. A GSP auction is not the only applicable environment for pricing ads, however, and the pricing component 1130 may be configured to determine a price for an ad in any relevant environment.

The displaying component 1140 is configured for, among other things, displaying the one or more ads. In particular, the displaying component 1140 may be configured to display the one or more ads in the order determined by the ranking component 1120.

It will be understood by those of ordinary skill in the art that computing system architecture 1100 is merely exemplary. While the ranking engine 1108 is illustrated as a single unit, one skilled in the art will appreciate that the ranking engine 1108 is scalable. For example, the ranking engine 1108 may in actuality include a plurality of components in communication with one another. Moreover, the database 1104 may be included within the ranking engine 1108 or user device 1102 as a computer-storage medium. The single unit depictions are meant for clarity, not to limit the scope of embodiments in any form.

Turning now to FIG. 12, a flow diagram is depicted of an exemplary method 1200 of ranking ads. Initially, at block 1202, one or more ads in an auction are identified. The auction may be a GSP auction. At block 1204 a score is calculated for each of the one or more ads using a reserve price. In an embodiment, the score is calculated using Equation 1 illustrated above. At block 1206 the one or more ads are ranked using the score calculated from the reserve price.

Turning now to FIG. 13, a flow diagram is depicted of an exemplary method 1300 of ranking ads. Initially, at block 1302, a search query is received. At block 1304 one or more ads associated with the search query are identified, where the one or more ads are included in an auction for the search query. The auction may be a GSP auction. At block 1306 a score is calculated for each of the one or more ads using each of a bid, a reserve price, and a click probability. At block 1308 the one or more ads are ranked based on the score utilizing the reserve price. At block 1310 a price is associated with each of the one or more ads.

It will be understood by those of ordinary skill in the art that the order of steps explained above are not meant to limit the scope of the embodiments of invention in any way and, in fact, the steps may occur in a variety of different sequences within embodiments hereof. Any and all such variations, and any combination thereof, are contemplated to be within the scope of embodiments of the invention. Alternative embodiments will become apparent to those of ordinary skill in the art to which the embodiments of the invention pertains without departing from its scope.

From the foregoing, this innovation is one well adapted to attain all the ends and objects set forth above, together with other advantages which are obvious and inherent to the system and method. It should be understood that certain features and subcombinations are of utility and may be employed without reference to other features and subcombinations. This is contemplated by and is within the scope of the claims.

What is claimed is:

1. One or more computer-storage media having computer-executable instructions embodied thereon that, when executed by one or more computing devices, perform a method of ranking ads, the method comprising:
identifying one or more advertisements in an auction;
calculating a score for each of the one or more advertisements using a reserve price; and
ranking the one or more advertisements using the score calculated utilizing the reserve price.

2. The media of claim 1, wherein the reserve price is a minimum bid required to have an advertisement displayed.

3. The media of claim 1, wherein the score is calculated using the following equation:
{(bᵢ−r)wᵢ}, where bᵢ is the bid submitted by the advertiser, r is the reserve price, and wᵢ is the click probability.

4. The media of claim 1, further comprising identifying a price to associate with each of the one or more advertisements.

5. The media of claim 4, wherein the price associated with a winning advertisement is a minimum price necessary to maintain a position.

6. The media of claim 1, wherein further comprising displaying the one or more advertisements based on the score.

7. The media of claim 1, wherein calculating the score is based on each of the reserve price, a bid submitted by an advertiser, and a click probability.

8. The method of claim 1, wherein calculating the score is based on the reserve price and a relevance of an advertisement.

9. The method of claim 1, wherein the auction is a generalized second price auction.

10. A system for ranking ads, the system comprising:
one or more processors coupled to a computer storage medium, the computer storage medium having stored thereon a plurality of computer software components executable by the processor, the computer software components comprising:
a calculating component for calculating a score for each of one or more advertisements associated with a search query, wherein the score is calculated based on a reserve price;
a ranking component for ranking the one or more advertisements based on the score for each of the one or more advertisements, wherein the score utilizes the reserve price; and
a pricing component for associating a price with each of the one or more advertisements based on the score.

11. The system of claim 10, wherein the system calculates a score for one or more advertisements that is included in a generalised second price auction.

12. The system of claim 10, wherein the calculating component calculates the score further based on a bid and a click probability.

13. The system of claim 10, wherein the reserve price is a minimum bid required for an advertisement to be displayed.

14. The system of claim 10, wherein the calculating component calculates the score further based on a relevance of at least one of the one or more advertisements.

15. The system of claim 10, further comprising a displaying component for displaying the one or more advertisements in accordance with the scores.

16. The system of claim 10, wherein the calculating components uses the following equation:
{(bᵢ−r)wᵢ}, where bᵢ is the bid submitted by the advertiser, r is the reserve price, and wᵢ is the click probability.

17. One or more computer-storage media having computer-executable instructions embodied thereon that, when executed by one or more computing devices, perform a method of ranking ads, the method comprising:
receiving a search query;
identifying one or more advertisements associated with the search query that are included in an auction for the search query;
calculating a score for each of the one or more advertisements using each of a bid submitted for each of the one or more advertisements, a reserve price, and a click probability associated with each of the one or more advertisements;
ranking the one or more advertisements based on the score calculated from the bid, the reserve price, and the click probability; and
associating a price with each of the one or more advertisements based on the score.

18. The media of claim 17, wherein the auction is a generalised second price auction.

19. The media of claim 17, wherein the reserve price is a minimum bid required for an advertisement to be displayed.

20. The media of claim 17, wherein the click probability is a likelihood that an advertisements will be selected upon display to a user.
